(19) United States
(12) Patent Application Publication
(10) Pub. No.: US 2012/0025642 A1
(43) Pub. Date: Feb. 2, 2012

(54) ROTATING ELECTRIC MACHINE

(75) Inventors: Sadahisa Onimaru, Nishio-shi (JP); Ryotarou Okamoto, Nishio-shi (JP); Hirohito Matsui, Nishio-shi (JP); Tomohiko Miyamoto, Miyoshi-shi (JP); Eiji Yamada, Owariasahi-shi (JP)

(73) Assignees: TOYOTA JIDOSHA KABUSHIKI KAISHA, Toyota-shi, Aichi-ken (JP); NIPPON SOKEN, INC, Nishio-shi, Aichi-ken (JP)

(21) Appl. No.: 13/259,633

(22) PCT Filed: Apr. 17, 2009
(86) PCT No.: PCT/JP2009/057732

§ 371 Date: Sep. 23, 2011

(51) Int. Cl. H02K 1/32

(52) U.S. Cl. 310/64

(57) ABSTRACT

A rotating electric machine that can be improved in cooling performance is provided. An end plate includes an annular plate portion arranged to be spaced from a rotor in an axial direction and secured to a rotation shaft, and a tubular portion protruding from an outer edge of the annular plate portion to abut on an axial end surface of the rotor. A partition plate arranged between the rotor and an end plate forms a first space between the rotor and the partition plate and a second space between the annular plate portion and the partition plate. A communication passage allowing the first space and the second space to communicate with each other is formed in the partition plate at a radially outer side relative to a permanent magnet. A through hole extending through the annular plate portion in the axial direction is formed in the annular plate portion at a radially inner side relative to the permanent magnet.

### TECHNICAL FIELD

The present invention relates to a rotating electric machine, and more particularly relates to a rotating electric machine having a permanent magnet embedded therein.

### BACKGROUND ART

In a rotating electric machine having a permanent magnet embedded therein, a rare-earth magnet is occasionally used as the permanent magnet in order to realize high efficiency and size reduction. In particular, an Nd (neodymium) magnet having a considerably high magnetic characteristic is used occasionally. Such an Nd magnet is excellent in magnetic characteristic, but is poor in temperature characteristic because holding power becomes deteriorated as temperature increases (thermal demagnetization). In the Nd magnet, the deterioration of the holding power causes such a problem that the magnet is demagnetized in an irreversible manner because of an external anti-magnetic field. This problem results in deterioration of performance of the rotating electric machine. Hence, a cooling structure for the permanent magnet to be used in the rotating electric machine becomes important in terms of temperature control in the permanent magnet.

For the cooling structure of a rotating electric machine, a technique for allowing a cooling oil supplied from a rotor shaft to flow through a cavity between a rotor and an end plate and discharging the cooling oil out of a discharge port at an outer peripheral side of the end plate has conventionally been proposed (see, e.g., Japanese Patent Laying-Open No. 2005-006429 (Patent Literature 1)). Moreover, a technique for providing an oil passage in a rotor and cooling a magnet by an oil flow has been proposed (see, e.g., Japanese Patent Laying-Open No. 2008-178243 (Patent Literature 2)).

### CITATION LIST

### Patent Literature

PTL 1: Japanese Patent Laying-open No. 2005-006429
PTL 2: Japanese Patent Laying-open No. 2008-178243

### SUMMARY OF INVENTION

### Technical Problem

When a discharge port for a cooling oil is provided near the outermost periphery of an end plate, oil flowed into the cavity between the rotor and the end plate is sent toward the discharge port by centrifugal force, and is discharged out of the discharge port directly. This raises a problem in that an oil pool is not formed in the cavity, so that an oil flow to be in contact with the rotor and a magnet is not formed, leading to the impossibility of effective cooling by oil.

When the discharge port for a cooling oil is provided at the inner peripheral side, an oil pool is formed in the cavity at the outer peripheral side relative to the discharge port in the cavity. However, oil pooled in this oil pool is pressed against the outer peripheral side by centrifugal force, leading to a high internal pressure. This raises a problem in that oil newly supplied to the cavity cannot enter the oil pool, and the supplied oil is discharged without replacing the oil in the oil pool, as a result of which the oil in the oil pool cannot be replaced, so that oil cooling cannot work effectively.

The present invention was made in view of the above-described problems, and has a main object to provide a rotating electric machine that can be improved in cooling performance.

### Solution to Problem

A rotating electric machine of the present invention includes a rotation shaft provided so as to be rotatable, a rotor secured to the rotation shaft, a permanent magnet embedded in the rotor, an end plate holding the rotor, and a partition plate arranged between the rotor and the end plate. The end plate includes an annular plate portion arranged to be spaced from the rotor in an axial direction and secured to the rotation shaft, and a tubular portion protruding from an outer edge of the annular plate portion toward the rotor to abut on an axial end surface of the rotor. The partition plate is arranged to be spaced from both of the annular plate portion and the rotor in the axial direction so as to form a first space between the rotor and the partition plate and a second space between the annular plate portion and the partition plate. A coolant passage communicating with the first space is formed in the rotation shaft. A communication passage allowing the first space and the second space to communicate with each other is formed in the partition plate at a radially outer side relative to the permanent magnet. A through hole extending through the annular plate portion in the axial direction is formed in the annular plate portion at a radially inner side relative to the permanent magnet.

In the above-described rotating electric machine, the communication passage may be formed at the outermost peripheral part of the partition plate in a radial direction.

In the above-described rotating electric machine, the communication passage may be formed so as to correspond to the permanent magnet in circumferential position.

In the above-described rotating electric machine, a protruding portion protruding into the first space may be formed on at least one of the partition plate and the rotor.

In the above-described rotating electric machine, the protruding portions may be formed into a fin shape extending along the radial direction, and may be arranged at a greater spacing at a circumferential position where the permanent magnet is embedded.

### Advantageous Effects of Invention

According to the rotating electric machine of the present invention, the rotating electric machine can be improved in cooling performance.

### BRIEF DESCRIPTION OF DRAWINGS

FIG. 1 is a sectional view showing a rotating electric machine according to a first embodiment of the present invention.

FIG. 2 is an enlarged sectional view enlargedly showing part of the rotor shown in FIG. 1.

FIG. 3 is a partial sectional perspective view of an end plate.

FIG. 4 is a sectional view showing a state in which a coolant is pooled in a first space.

FIG. 5 is a sectional view showing a state in which the coolant is pooled in a second space.

FIG. 6 is a sectional view showing, from a different angle, a state in which the coolant is pooled in the first space and the second space.

FIG. 7 is a schematic view showing the shape of a partition plate of a second embodiment.

FIG. 8 is a sectional view of a rotor with the partition plate shown in FIG. 7 disposed therein.

FIG. 9 is an enlarged sectional view enlargedly showing part of a rotor of a rotating electric machine of a third embodiment.

FIG. 10 is a sectional view of the rotor taken along the line X-X shown in FIG. 9.

FIG. 11 is an enlarged sectional view enlargedly showing part of a rotor of a rotating electric machine of a fourth embodiment.

FIG. 12 is a sectional view of the rotor taken along the line XII-XII shown in FIG. 11.

FIG. 13 is an enlarged sectional view enlargedly showing part of a rotor of a rotating electric machine of a fifth embodiment.

FIG. 14 is a sectional view of the rotor taken along the line XIV-XIV shown in FIG. 13.

FIG. 15 is an enlarged sectional view enlargedly showing part of a rotor of a rotating electric machine of a sixth embodiment.

FIG. 16 is a sectional view of the rotor taken along the line XVI-XVI shown in FIG. 15.

FIG. 17 is a sectional view showing a variation of a protruding portion formed on an axial end surface of the rotor.

FIG. 18 is an enlarged sectional view enlargedly showing part of a rotor of a rotating electric machine of an eighth embodiment.

FIG. 19 is a sectional view of the rotor taken along the line XIX-XIX shown in FIG. 18.

### DESCRIPTION OF EMBODIMENTS

Hereinafter, embodiments of the present invention will be described referring to the drawings. In the drawings, identical or corresponding parts are shown with an identical reference numeral, and description thereof will not be repeated.

It is noted that, in embodiments as will be described below, each component is not necessarily essential for the present invention unless otherwise specified. When number, amount and the like are mentioned in the embodiments below, such number and the like are for illustration unless otherwise specified, and the scope of the present invention is not necessarily limited to such number, amount and the like.

### First Embodiment

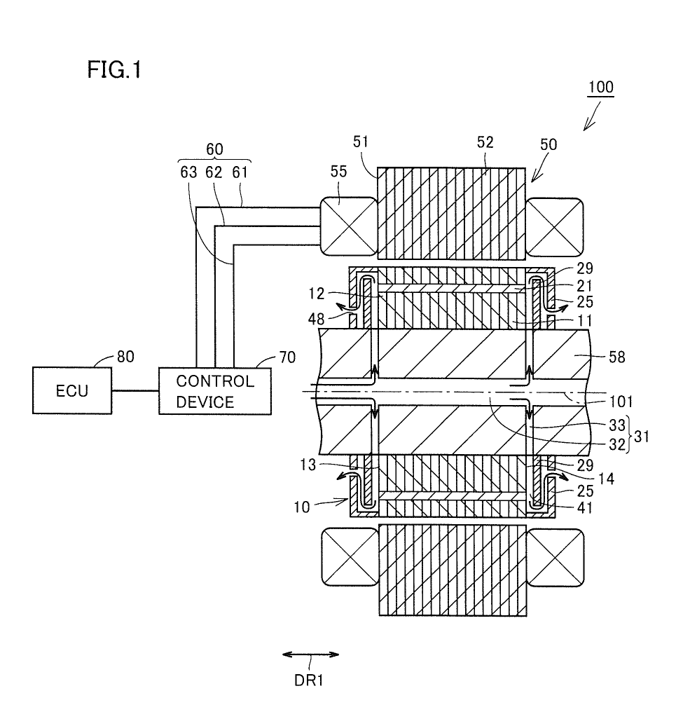

FIG. 1 is a sectional view showing a rotating electric machine 100 according to an embodiment of the present invention. Rotating electric machine 100 shown in the drawing is mounted on a hybrid vehicle having, as power sources, an internal combustion engine such as a gasoline engine or a diesel engine, and a motor supplied with electric power from a chargeable and dischargeable secondary cell (battery). Rotating electric machine 100 represents a motor generator having at least one of the function as a motor supplied with electric power to generate driving force and the function as a power generator (generator).

As shown in FIG. 1, rotating electric machine 100 includes a rotation shaft 58, a rotor 10 and a stator 50. Rotor 10 is secured to rotation shaft 58 extending along a center line 101. Rotation shaft 58 is provided so as to be rotatable together with rotor 10 about center line 101, which is an imaginary center line of rotation of rotation shaft 58, by a magnetic field generated in stator 50.

Rotor 10 includes a rotor core 11 and a permanent magnet 21 that is embedded in rotor core 11. That is, rotating electric machine 100 is an IPM (Interior Permanent Magnet) motor. Rotor core 11 has a cylindrical shape along center line 101. Rotor core 11 is composed of a plurality of electromagnetic steel plates 12 laminated in an axial direction (the direction along centerline 101 indicated by a double-headed arrow DR1 in FIG. 1).

Stator 50 is arranged on the outer circumference of rotor 10. Stator 50 includes a stator core 51 and a coil 55 wound around stator core 51. Stator core 51 is composed of a plurality of electromagnetic steel plates 52 laminated in the axial direction along center line 101. It is noted that rotor core 11 and stator core 51 are not limited to the electromagnetic steel plates, but may be integrally molded by, for example, a dust core.

Coil 55 is electrically connected to a control device 70 by way of a three-phase cable 60. Three-phase cable 60 consists of a U-phase cable 61, a V-phase cable 62 and a W-phase cable 63. Coil 55 consists of a U-phase coil, a V-phase coil and a W-phase coil, and U-phase cable 61, V-phase cable 62 and W-phase cable 63 are connected to terminals of these three coils, respectively.

An ECU (Electrical Control Unit) 80 mounted on the hybrid vehicle sends, to control device 70, a torque command value to be output from rotating electric machine 100. Control device 70 generates a motor control current for outputting a torque designated based on the torque command value, and feeds the motor control current to coil 55 through three-phase cable 60.

An end plate 25 is provided so as to be opposed to axial end surfaces 13, 14 located at the opposite ends of rotor 10 in the axial direction. End plate 25 holds the laminated structure of electromagnetic steel plates 12 constituting rotor 10 in the axial direction. When ends of electromagnetic steel plates 12, which are opposed to permanent magnet 21, are magnetized, a force will be exerted so as to separate electromagnetic steel plates 12 from each other by action of a magnetic force. However, arranging end plate 25 to hold the laminated structure of electromagnetic steel plates 12 prevents electromagnetic steel plates 12 from being separated from each other. End plate 25 is fixed to rotation shaft 58 by any method such as screwing, caulking or pressure fitting to be integrally rotatable, and makes a rotational movement along with rotation of rotation shaft 58.

A partition plate 29 is arranged between axial end surfaces 13, 14 of rotor 10 and end plate 25. Partition plate 29 is formed so as not to be relatively movable with respect to rotation shaft 58 in the axial direction.

Rotation shaft 58 is formed to be hollow. A coolant passage 31 is formed inside rotation shaft 58. Coolant passage 31 is formed such that a coolant, represented by a cooling oil, for cooling permanent magnet 21 can flow therethrough. Coolant passage 31 includes an axial passage 32 extending in the axial direction so as to involve center line 101. Coolant passage 31 also includes a radial passage 33 provided in communication with axial passage 32 and extending in a radial direction of rotation shaft 58.

A cavity communicating with radial passage 33 is formed between end plate 25 and axial end surface 13, 14 of rotor 10. This cavity forms a coolant passage 41. Coolant passage 41 is formed such that the coolant for cooling permanent magnet 21 can flow therethrough. End plate 25 has a through hole 48 formed therein that extends through end plate 25 in the axial direction so as to allow coolant passage 41 to communicate with the outside.

As shown by arrows in FIG. 1, the coolant for cooling permanent magnet 21 is transferred from a pump not shown, passes through axial passage 32 and radial passage 33, and is introduced into coolant passage 41. The coolant supplied to coolant passage 41 can be discharged from coolant passage 41 via through hole 48.

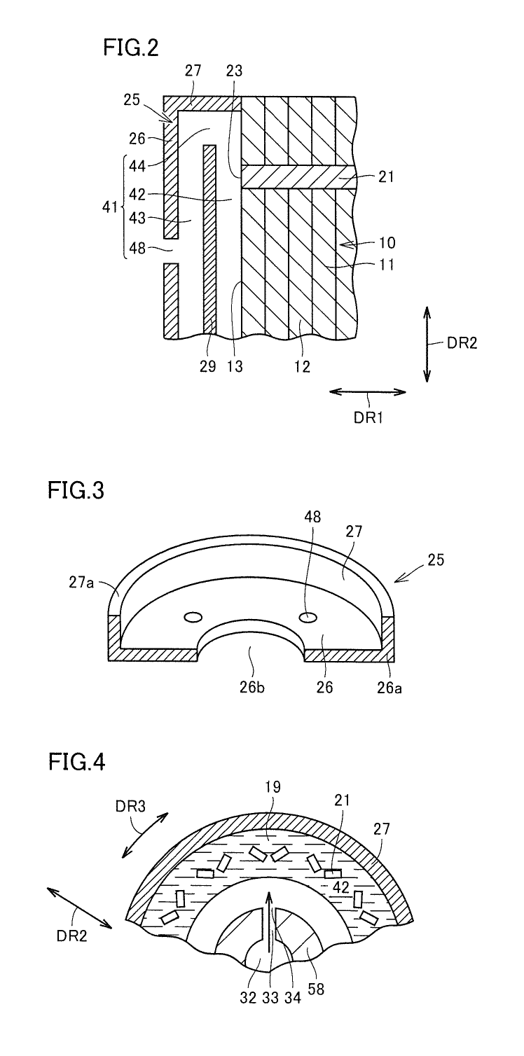

FIG. 2 is an enlarged sectional view enlargedly showing part of rotor 10 shown in FIG. 1. FIG. 3 is a partial sectional perspective view of end plate 25. As shown in FIGS. 2 and 3, end plate 25 includes a disc-shaped annular plate portion 26 and a tubular portion 27 protruding from an outer edge 26a of annular plate portion 26. A hole 26b is formed in the central portion of annular plate portion 26. Rotation shaft 58 is inserted through this hole 26b to allow annular plate portion 26 to be secured to rotation shaft 58, so that end plate 25 is fixed to rotation shaft 58.

As shown in FIG. 2, annular plate portion 26 is arranged to be separated from axial end surface 13 of rotor 10 in the axial direction. Tubular portion 27 protrudes from annular plate portion 26 toward axial end surface 13 of rotor 10. A circular leading end surface 27a (see FIG. 3) of tubular portion 27 abuts on axial end surface 13 of rotor 10, so that the laminated structure of electromagnetic steel plates 12 is held in the axial direction.

Partition plate 29 is arranged to be separated from both of annular plate portion 26 of end plate 25 and axial end surface 13 of rotor 10 in the axial direction. The cavity between end plate 25 and axial end surface 13 of rotor 10 is partitioned by partition plate 29. Partition plate 29 partitions the space surrounded by annular plate portion 26, tubular portion 27, axial end surface 13 of rotor 10, and the outer peripheral surface of rotation shaft 58 in the axial direction to be divided into two, thereby forming a first space 42 between rotor 10 and partition plate 29 and a second space 43 between annular plate portion 26 and partition plate 29.

First space 42 is defined by axial end surface 13 of rotor 10 and a surface of partition plate 29 opposed to rotor 10. Second space 43 is defined by surfaces of annular plate portion 26 and partition plate 29 opposed to each other. The outer peripheral surface of rotation shaft 58 defines the radially innermost wall surfaces of first space 42 and second space 43. The inner peripheral surface of tubular portion 27 defines the radially outermost wall surfaces of first space 42 and second space 43.

Partition plate 29 is formed into a disc shape smaller in diameter than the inner diameter of tubular portion 27. Partition plate 29 is arranged such that the outer edge of partition plate 29 is opposed to tubular portion 27. A communication passage 44 is formed between the outermost peripheral part of partition plate 29 most distant from center line 101 in the radial direction (the direction indicated by a double-headed arrow DR2 in FIG. 2 and orthogonal to the axial direction) and tubular portion 27. Communication passage 44 is formed to extend through partition plate 29 in the axial direction so as to allow first space 42 and second space 43 to communicate with each other.

Through hole 48 extending through annular plate portion 26 in the axial direction is formed in annular plate portion 26 of end plate 25. Through hole 48 allows outer space opposite to rotor 10 relative to annular plate portion 26 and second space 43 to communicate with each other.

A hole portion is formed in rotor core 11 so as to extend through rotor core 11 along the axial direction of the cylindrical shaft. Permanent magnet 21 is inserted into this hole portion to be embedded in rotor 10. Permanent magnet 21 is arranged to extend through rotor 10 in the axial direction such that axial end surface 23 of permanent magnet 21 is exposed in first space 42.

First space 42, communication passage 44, second space 43, and through hole 48 constitute coolant passage 41. Radial passage 33 formed within rotation shaft 58 communicates with first space 42. First space 42 is connected to radial passage 33. As shown in FIG. 2, communication passage 44 is formed at the radially outer side relative to permanent magnet 21. Through hole 48 is formed at the radially inner side relative to permanent magnet 21.

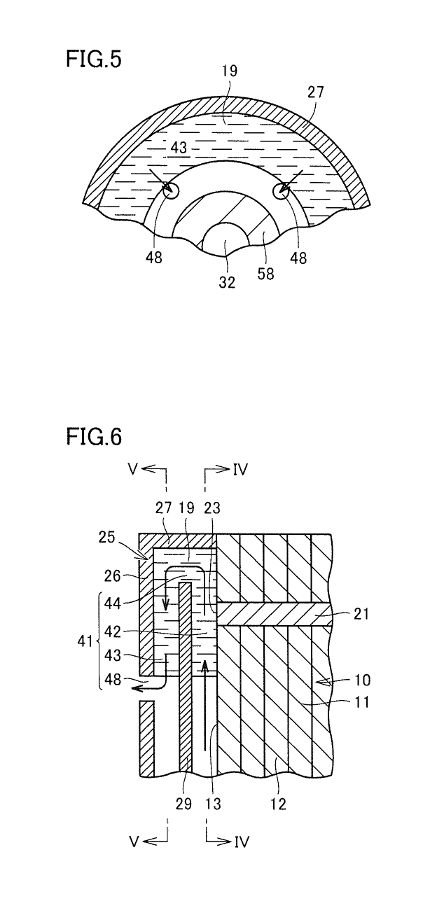

FIG. 4 is a sectional view showing a state in which the coolant is pooled in first space 42. FIG. 5 is a sectional view showing a state in which the coolant is pooled in second space 43. FIG. 6 is a sectional view showing, from a different angle, a state in which the coolant is pooled in first space 42 and second space 43. FIGS. 4 and 5 show the section orthogonal to the axial direction of rotor 10. FIG. 6 shows the section along the axial direction of rotor 10. It is noted that FIG. 4 is a sectional view of rotor 10 taken along the line IV-IV shown in FIG. 6, and FIG. 5 is a sectional view of rotor 10 taken along the line V-V shown in FIG. 6. Arrows shown in FIGS. 4 to 6 indicate the coolant flow.

As shown in FIGS. 4 and 6, the coolant supplied to radial passage 33 via axial passage 32 within rotation shaft 58 flows to the radially outer side by the action of centrifugal force generated by rotation of rotor 10. The coolant flows through radial passage 33 into first space 42, passing through communication port 34 that allows radial passage 33 and first space 42 to communicate with each other. The coolant flows in first space 42 to the radially outer side while being in contact with axial end surface 13 of rotor 10 and the surface of partition plate 29 opposed to rotor 10, to arrive at axial end surface 23 of permanent magnet 21 exposed in first space 42. Since the coolant flows while being in contact with axial end surface 23 of permanent magnet 21, axial end surface 23 of permanent magnet 21 is cooled by the coolant.

As shown in FIG. 6, the coolant arrived at the outermost peripheral part in the radial direction in first space 42 flows into second space 43 passing through communication passage 44 formed at the outermost peripheral part of partition plate 29. The coolant flows in second space 43 to the radially inner side, arrives at through hole 48 formed in annular plate portion 26, and is discharged out of through hole 48 to the outside.

Through hole 48 is opened in a portion located at the radially inner side relative to permanent magnet 21. Accordingly, as shown in FIGS. 5 and 6, a coolant pool 19 in which the coolant is pooled is formed in first space 42 and second space 43 at the outer peripheral side relative to the radial position at which through hole 48 is formed.

With the structure of the present embodiment, the outer peripheral side of partition plate 29 is sank in the coolant pooled in coolant pool 19. This causes a difference between the gas pressure in first space 42 and the gas pressure in second space 43, the gas pressure in first space 42 being relatively higher. The coolant flow is thus produced in coolant pool 19 as well, as a result of which the coolant flows without stagnation to flow from first space 42 to second space 43 via communication passage 44, and is discharged out of through hole 48.

That is, according to the present embodiment, formation of coolant pool 19 always brings axial end surface 23 of permanent magnet 21 having a low thermal resistance into contact with the coolant. Also, formation of the coolant flow without stagnation such that the coolant is not retained within coolant pool 19 allows the coolant at a low temperature to be always supplied to axial end surface 23 of permanent magnet 21. Permanent magnet 21 can thus be cooled efficiently, which can prevent permanent magnet 21 from causing thermal demagnetization that would result from temperature rise and prevent permanent magnet 21 from deteriorating in holding power.

Moreover, disposing partition plate 29 between rotor 10 and end plate 25 enables formation of coolant pool 19 and formation of the coolant flow in coolant pool 19, so that an effective method of cooling permanent magnet 21 with an easy structure can be provided. End plate 25 is configured by a combination of disc-shaped annular plate portion 26 and sleeve-shaped tubular portion 27, partition plate 29 is of disc shape, and end plate 25 and partition plate 29 can be molded easily, which can reduce the manufacturing cost and simplify the manufacturing process of rotating electric machine 100.

Coolant pool 19 is formed at the outer peripheral side relative to the radial position at which through hole 48 is formed. That is, if the position of through hole 48 in the radial direction is changed, the depth of coolant pool 19 can be freely changed. By changing the depth of coolant pool 19, a surface area of axial end surface 13 of rotor 10 always covered with the coolant can be changed freely. Therefore, the coverage by which the coolant covers rotor 10 can be changed freely in accordance with the cooling performance required by rotor 10. Since this change in coverage can be achieved only by changing the position of through hole 48 in the radial direction, any coverage can be obtained easily, without increasing the manufacturing cost of rotating electric machine 100.

Through hole 48 out of which the coolant is discharged to the outside is formed at the radially inner side of end plate 25. This controls centrifugal force to be exerted on the coolant scattering out of through hole 48, which can minimize the loss generated when the coolant is discharged. In addition, the coolant flowed out of through hole 48 can be prevented from entering the clearance between rotor 10 and stator 50, which can avoid increase in rubbing loss during rotation of rotor 10.

### Second Embodiment

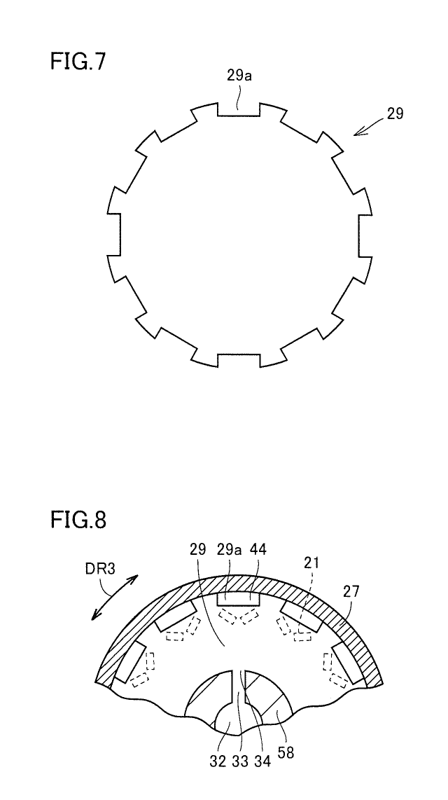

FIG. 7 is a schematic view showing the shape of partition plate 29 of a second embodiment. FIG. 8 is a sectional view of rotor 10 with partition plate 29 shown in FIG. 7 disposed therein. The section shown in FIG. 8 is a section of rotor 10 taken in the axial direction along the line IV-IV shown in FIG. 6 and viewed toward partition plate 29 in the opposite direction of the line IV-IV. While partition plate 29 of the first embodiment is formed into a disc shape, partition plate 29 of the second embodiment shown in FIG. 7 differs from that of the first embodiment in that a plurality of notches 29a are formed at the outer edge.

With reference to FIG. 8, partition plate 29 is positioned in the circumferential direction (the direction along the arc of cylindrical rotation shaft 58 or tubular portion 27, indicated by a double-headed arrow DR3 shown in FIG. 8) such that notches 29a are arranged at the radially outer side relative to permanent magnet 21. At this time, partition plate 29 is attached to rotation shaft 58 so as not to be relatively rotatable, and partition plate 29 is configured to rotate integrally with rotor 10 so that the relative positions of permanent magnet 21 and notches 29a in the circumferential direction do not change. Partition plate 29 is formed to have an outer diameter equal to or slightly smaller than the inner diameter of tubular portion 27 such that the outer peripheral part at which no notch 29a is formed abuts on the inner peripheral surface of tubular portion 27.

The coolant flowing from first space 42 to second space 43 flows through notches 29a formed in partition plate 29. That is, notches 29a of partition plate 29 constitute communication passage 44 that allows first space 42 and second space 43 to communicate with each other. By positioning partition plate 29 in the circumferential direction as described above, communication passage 44 is fanned so as to correspond to permanent magnet 21 in circumferential position.

The coolant supplied through radial passage 33 of rotation shaft 58 into first space 42 via communication port 34 flows into communication passage 44. By specifying the position of communication passage 44, the coolant flow in first space 42 can be created so as to ensure the coolant to flow while being in contact with axial end surface 23 of permanent magnet 21. Therefore, permanent magnet 21 can be cooled more efficiently.

### Third Embodiment

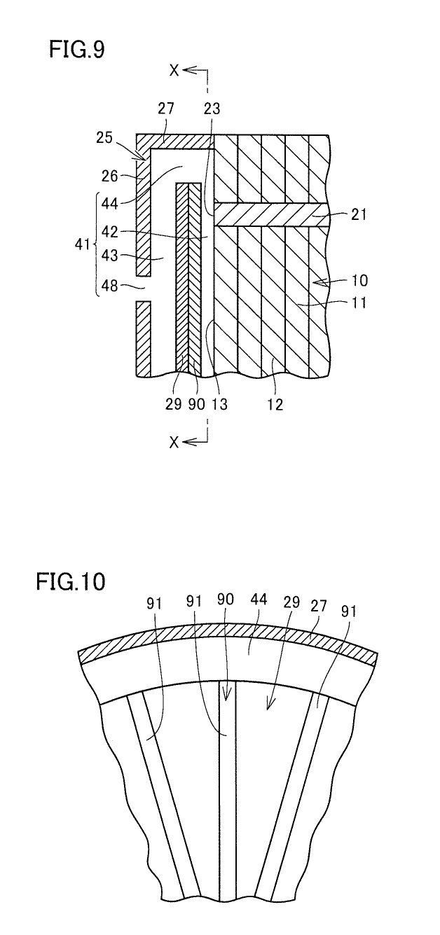

FIG. 9 is an enlarged sectional view enlargedly showing part of rotor 10 of rotating electric machine 100 of a third embodiment. FIG. 10 is a sectional view of rotor 10 taken along the line X-X shown in FIG. 9. As shown in FIGS. 9 and 10, a protruding portion 90 protruding into first space 42 is formed in partition plate 29 of the third embodiment. Protruding portion 90 has a plurality of fin-shaped protruding portions 91 extending in the radial direction, as shown in FIG. 10.

Axial end surface 23 of permanent magnet 21 is exposed in first space 42. Then, providing radial protruding portions 91 protruding into first space 42 can disturb the coolant flow in first space 42, such as by producing a vortex or turbulence in first space 42, since protruding portions 91 cause obstruction to the coolant flow flowing in first space 42 to the radially outer side. The coolant at a low temperature can thus be brought into contact with axial end surface 23 of permanent magnet 21 more efficiently, which can further improve permanent magnet 21 in cooling performance.

It is noted that partition plate 29 needs to be made of a non-magnetic material so as to prevent magnetic flux leakage, and partition plate 29 can be made of any non-magnetic material. For example, partition plate 29 can be formed using a thin plate of about 1 mm thick made of a metallic material, such as aluminium superior in workability. Since working is facilitated when aluminium is used, partition plate 29 can be easily molded into any shape by any machining such as press working.

### Fourth Embodiment

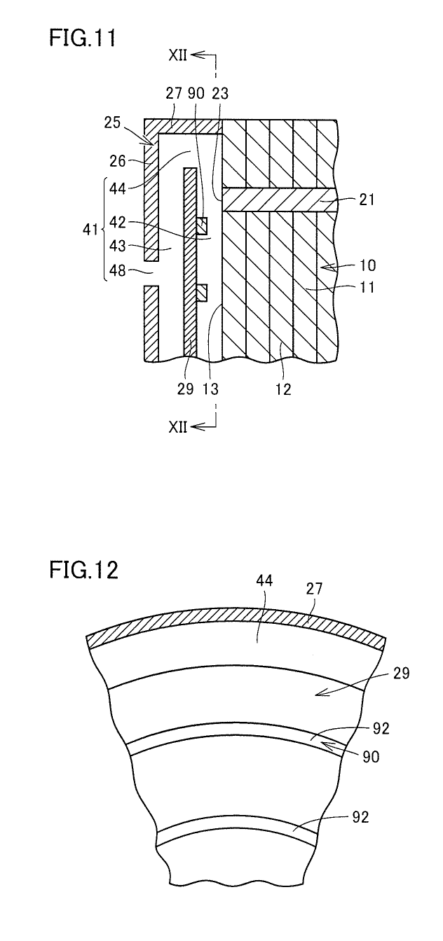

FIG. 11 is an enlarged sectional view enlargedly showing part of rotor 10 of rotating electric machine 100 of a fourth embodiment. FIG. 12 is a sectional view of rotor 10 taken along the line XII-XII shown in FIG. 11. As shown in FIGS. 11 and 12, protruding portion 90 protruding into first space 42 is formed in partition plate 29 of the fourth embodiment. Protruding portion 90 has a plurality of fin-shaped protruding portions 92 extending in the circumferential direction, as shown in FIG. 12.

Similarly to the third embodiment, by providing protruding portions 92, the coolant flow in first space 42 can be disturbed, and the coolant at a low temperature can be brought into contact with axial end surface 23 of permanent magnet 21 more efficiently, which can further improve permanent magnet 21 in cooling performance.

### Fifth Embodiment

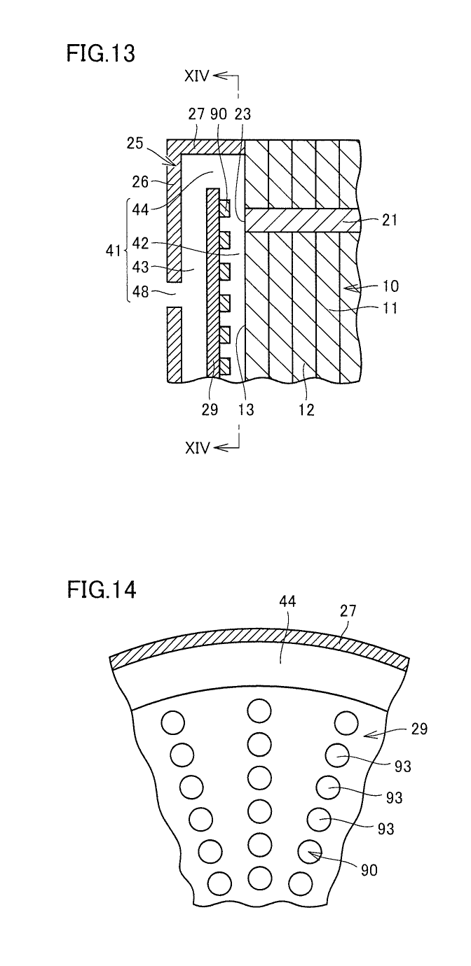

FIG. 13 is an enlarged sectional view enlargedly showing part of rotor 10 of rotating electric machine 100 of a fifth embodiment. FIG. 14 is a sectional view of rotor 10 taken along the line XIV-XIV shown in FIG. 13. As shown in FIGS. 13 and 14, protruding portion 90 protruding into first space 42 is formed in partition plate 29 of the fifth embodiment. Protruding portion 90 has a plurality of independently-formed protruding portions 93, as shown in FIG. 14.

Similarly to the third embodiment, by providing protruding portions 93, the coolant flow in first space 42 can be disturbed, and the coolant at a low temperature can be brought into contact with axial end surface 23 of permanent magnet 21 more efficiently, which can further improve permanent magnet 21 in cooling performance.

### Sixth Embodiment

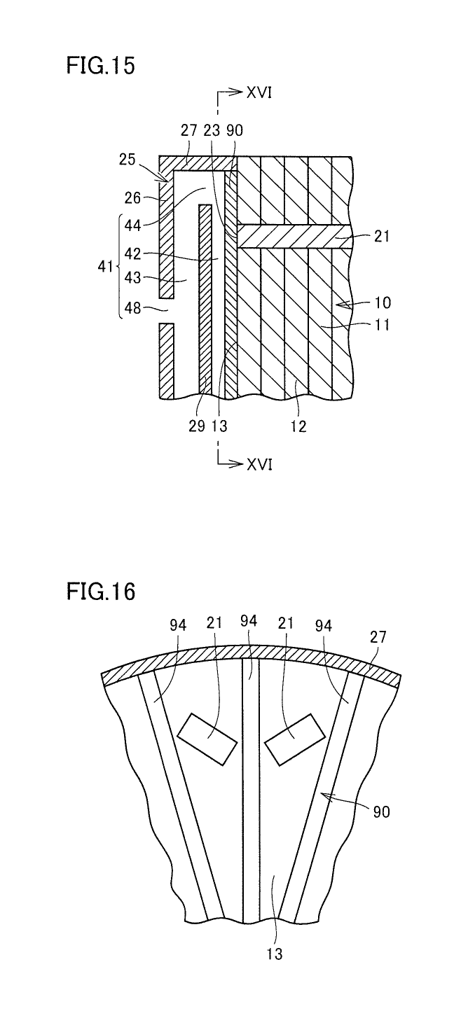

FIG. 15 is an enlarged sectional view enlargedly showing part of rotor 10 of rotating electric machine 100 of a sixth embodiment. FIG. 16 is a sectional view of rotor 10 taken along the line XVI-XVI shown in FIG. 15. Unlike the third to fifth embodiments, partition plate 29 is in the form of flat plate in the sixth embodiment, and protruding portion 90 protruding from axial end surface 13 of rotor 10 into first space 42 is formed. Protruding portion 90 has a plurality of fin-shaped protruding portions 94 extending along the radial direction, as shown in FIG. 16.

Similarly to the third embodiment, by providing protruding portions 94, the coolant flow in first space 42 can be disturbed, and the coolant at a low temperature can be brought into contact with axial end surface 23 of permanent magnet 21 more efficiently, which can further improve permanent magnet 21 in cooling performance. In addition, the surface area of rotor 10 exposed in first space 42 is increased because protruding portion 90 is formed on rotor 10. This can increase the contact area of rotor 10 with the coolant flowing in first space 42, which can further improve rotor 10 in cooling efficiency.

### Seventh Embodiment

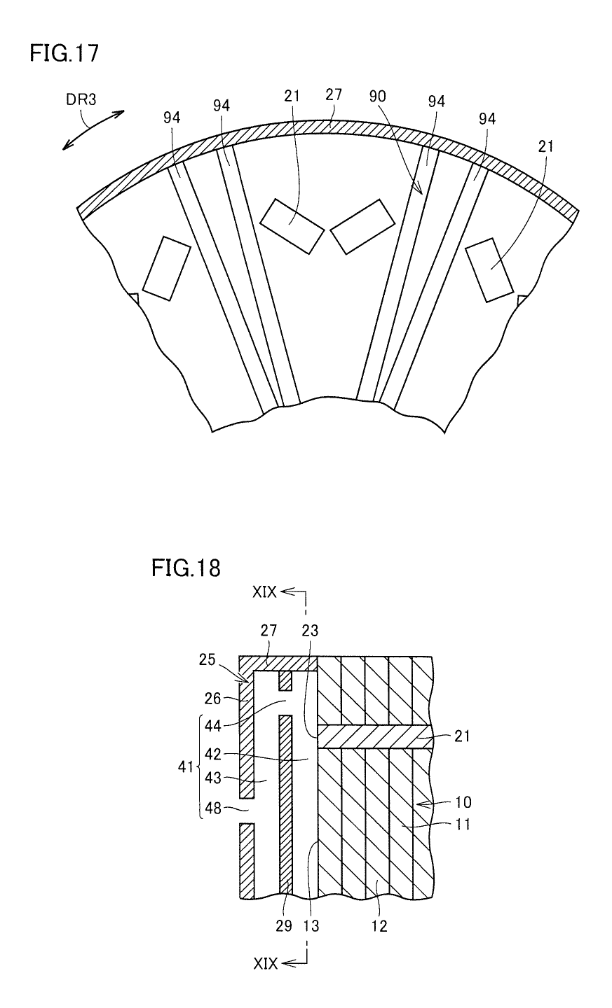

FIG. 17 is a sectional view showing a variation of protruding portion 90 formed on axial end surface 13 of rotor 10. Protruding portion 90 of the seventh embodiment has a plurality of fin-shaped protruding portions 94 extending along the radial direction. While fin-shaped protruding portions 94 of the sixth embodiment are arranged uniformly in the circumferential direction, protruding portions 94 of the seventh embodiment are arranged at irregular spacings in the circumferential direction. Specifically, protruding portions 94 are arranged at a greater spacing at the circumferential position where permanent magnet 21 is embedded.

Then, the coolant is less likely to flow in the space at the circumferential position where spacing between adjacent protruding portions 94 is relatively small and where permanent magnet 21 is not disposed. In contrast, the coolant is more likely to flow in the space at the circumferential position where permanent magnet 21 is embedded, so that a greater amount of coolant comes into contact with permanent magnet 21. Therefore, a passage of the coolant can be formed targeting at permanent magnet 21, and the coolant at a low temperature can be brought into contact with axial end surface 23 of permanent magnet 21 more efficiently, which can further improve permanent magnet 21 in cooling performance.

### Eighth Embodiment

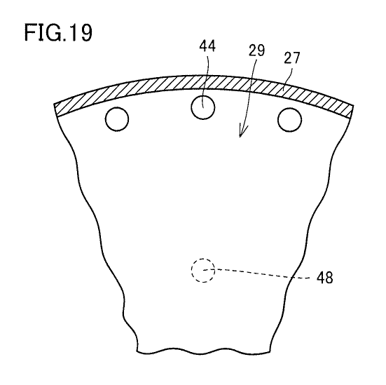

FIG. 18 is an enlarged sectional view enlargedly showing part of rotor 10 of rotating electric machine 100 of an eighth embodiment. FIG. 19 is a sectional view of rotor 10 taken along the line XIX-XIX shown in FIG. 18. In the first embodiment, partition plate 29 is formed to have an outer diameter smaller than the inner diameter of tubular portion 27, and communication passage 44 is formed between partition plate 29 and tubular portion 27, however, as shown in FIGS. 18 and 19, it may be configured such that a through hole extending through partition plate 29 along its thickness is formed at the outer peripheral part, and such that this through hole allows first space 42 and second space 43 to communicate with each other.

The through hole formed at the outer peripheral part of partition plate 29 is not limited to the circular hole shown in FIG. 19. For example, the through hole may be made as a long hole extending in the circumferential direction, and partition plate 29 may be positioned such that communication passage 44 formed by this long hole corresponds to permanent magnet 21 in circumferential position. This can ensure that the coolant flow is formed on axial end surface 23 of permanent magnet 21 similarly to the second embodiment, which allows permanent magnet 21 to be cooled more efficiently.

It is noted that, although the foregoing describes a rotating electric machine mounted on a hybrid vehicle and functioning as a driving source driving wheels and a power generator generating power with power of an engine or the like, the rotating electric machine of the present invention can also be mounted on a fuel-cell vehicle, an electric vehicle or the like, and utilized as a driving source driving wheels.

While the embodiments of the present invention are described above, the structures of the respective embodiments may be combined as appropriate. It should be understood that the embodiments disclosed herein are illustrative and non-restrictive in any respect. The scope of the present invention is defined by the terms of the claims, rather than the description above, and is intended to include any modifications within the scope and meaning equivalent to the terms of the claims.

### INDUSTRIAL APPLICABILITY

The rotating electric machine of the present invention is applicable particularly advantageously to a rotating electric machine mounted on a vehicle.

### REFERENCE SIGNS LIST

10 rotor; 11 rotor core; 12, 52 electromagnetic steel plate; 13, 14, 23 axial end surface; 21 permanent magnet; 25 end plate; 26 annular plate portion; 26a outer edge; 26b hole; 27 tubular portion; 27a leading end surface; 29 partition plate; 29a notch; 31 coolant passage; 32 axial passage; 33 radial passage; 34 communication port; 41 coolant passage; 42 first space; 43 second space; 44 communication passage; 48 through hole; 50 stator; 51 stator core; 55 coil; 58 rotation shaft; 90, 91, 92, 93, 94 protruding portion; 100 rotating electric machine; 101 center line.

1. A rotating electric machine comprising:
a rotation shaft provided so as to be rotatable;
a rotor secured to said rotation shaft;
a permanent magnet embedded in said rotor;
an end plate holding said rotor; and
a partition plate arranged between said rotor and said end plate,
said end plate including an annular plate portion arranged to be spaced from said rotor in an axial direction and secured to said rotation shaft, and a tubular portion protruding from an outer edge of said annular plate portion toward said rotor to abut on an axial end surface of said rotor,
said partition plate being arranged to be spaced from both of said annular plate portion and said rotor in the axial direction so as to form a first space between said rotor and said partition plate and a second space between said annular plate portion and said partition plate,
a coolant passage communicating with said first space being formed in said rotation shaft,
a communication passage allowing said first space and said second space to communicate with each other being formed in said partition plate at a radially outer side relative to said permanent magnet, and
a through hole extending through said annular plate portion in said axial direction being formed in said annular plate portion at a radially inner side relative to said permanent magnet.

2. The rotating electric machine according to claim 1, wherein said communication passage is formed at the outermost peripheral part of said partition plate in a radial direction.

3. The rotating electric machine according to claim 1, wherein said communication passage is formed so as to correspond to said permanent magnet in circumferential position.

4. The rotating electric machine according to claim 1, wherein a protruding portion protruding into said first space is formed on at least one of said partition plate and said rotor.

5. The rotating electric machine according to claim 4, wherein said protruding portions are formed into a fin shape extending along the radial direction, and are arranged at a greater spacing at a circumferential position where said permanent magnet is embedded.
